(19) United States
(12) Patent Application Publication
(10) Pub. No.: US 2006/0078487 A1
(43) Pub. Date: Apr. 13, 2006

(54) Three dimensional high regular nano-porous inorganic material having fine pores and method for preparation thereof, and method for evaluation thereof

(75) Inventors: Akira Endo, Tsukuba-shi (JP); Tatsuhiko Miyata, Tsukuba-shi (JP); Takao Ohmori, Tsukuba-shi (JP); Takaji Akiya, Tsukuba-shi (JP); Masaru Nakaiwa, Tsukuba-shi (JP); Takashi Nakane, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NATIONAL INSTITUTE OF ADVANCED INDUSTRIAL SCIENCE, Tokyo (JP)

(21) Appl. No.: 10/514,912

(22) PCT Filed: Feb. 28, 2003
(86) PCT No.: PCT/JP03/02321

§ 371 Date: Aug. 16, 2005

(30) Foreign Application Priority Data
May 17, 2002 (JP) 2002-143808

(51) Int. Cl. C01F 3/00; C01B 33/00; C01B 33/26

(52) U.S. Cl. 423/324; 423/327.1; 423/111

(57) ABSTRACT

A nanoporous inorganic material with high three-dimensional regularity having a large number of fine pores having a nanometer-order size in an inorganic skeleton structure, which has a pore size of 0.5 to 5 nm at a peak of a pore size distribution determined from a nitrogen adsorption isotherm, and a half-width of 1 (2θ/degree) or less in an X-ray diffraction peak of a (100) plane.

### FIELD OF THE INVENTION

The present invention relates to a nanoporous inorganic material with high three-dimensional regularity having fine pores on a nanometer order, which are usable in the form of fine particles, granules, flakes or membranes as adsorbents, separating membranes, reaction membranes, catalysts, catalyst carriers, etc., and methods for producing and evaluating such a nanoporous inorganic material.

### BACKGROUND OF THE INVENTION

Conventionally known porous silica is, for instance, a porous laminar silica-metal oxide material having a large number of pores of 10 Å or more in diameter and a structure, in which an interlaminar cross-linked SiO₂ is formed by the dehydration bonding of silicic acid between lamellar crystals of silicon tetrahedron SiO₄, and acting as a solid acid formed by the bonding of other metal atoms than silicon to the above lamellar crystal (JP 4-238810 A). The production of this porous silica is carried out by a method, in which metal atoms are added when an organic material is introduced into the lamellar crystals of silicon tetrahedron, or by a method of forming the interlaminar cross-linking of SiO₂ between layers after introducing an organic material and then introducing metal atoms. In any case, 4 or 6 metal atoms are coordinated on the lamellar crystal surface. As another porous silica, JP 3-199118 A discloses porous silica having a sandwich structure, in which a silicon tetrahedron layer and a metal octahedron layer are alternately laminated. However, these porous materials do not have regularly aligned fine pores, with a wide pore size distribution.

It was recently found that porous materials having regularly aligned fine pores with a uniform pore size on a nanometer order are excellent in gas adsorption and separation of various substances. Accordingly, various methods for producing such porous materials have been proposed.

For instance, a method for producing an inorganic porous material comprising forming an inorganic material-surfactant complex with high three-dimensional regularity by hydrothermal synthesis using an assembly of an alkyltrimethylammonium surfactant as a template (mold), and sedimentary silica, colloidal silica, water glass, alkoxysilane, etc. as starting materials, and firing the complex to remove organic materials therefrom is proposed [J. S. Beck et al. J. Am. Chem. Soc., 114, 10834 (1992)]. The concentration of the surfactant is higher than a critical micelle concentration and lower than the concentration of forming a liquid crystal phase, for instance, 25% by weight, and the pH of the solution is 10 to 13 on the alkaline side. The standard reaction conditions are 100° C. or higher and 2 days.

Porous materials obtained by this hydrothermal synthesis have regularly aligned fine pores with much more uniform sizes than those of conventional porous materials. However, it has been found that a narrower pore size distribution and higher three-dimensional regularity are required to improve the gas adsorption of porous materials. In addition, because the hydrothermal synthesis should be conducted at as high a temperature as 100° C. or higher for a long period of time, needing an air-tight container such as an autoclave, it is disadvantageous in a high production cost of porous materials.

Further proposed is a method of using kanemite (obtained by firing amorphous sodium silicate, and immersing it in water) as a starting material; dispersing kanemite as a surfactant in a halogenated alkyltrimethylammonium solution; heating the solution under the conditions of pH 11.5 to 12.3 and 70° C. for 3 hours, so that the halogenated alkyltrimethylammonium is regularly arranged between kanemite layers; reducing the pH of the solution to 8.5 at the same temperature to form a stable three-dimensional silicate skeleton; and drying and firing it to remove the surfactant, thereby providing the porous material (JP 8-277105 A).

Though the method of using kanemite is advantageous in not requiring so high temperature and so long period of time as in the hydrothermal synthesis, the resultant porous material has poorer three-dimensional regularity because fine pores are formed by causing the surfactant to enter between the kanemite layer, and is likely to loose fine pores by temperature elevation because of a residual stress. In addition, it has been found that the partition walls of fine pores in the resultant porous material cannot be made sufficiently thin.

Further, it has recently become important to accurately evaluate the pore size and its distribution of an inorganic porous material such as porous silica used as a gas adsorbent, because the pore size and its distribution greatly affect the characteristics of the adsorbent. With respect to the evaluation of the pore size distribution of porous silica, many methods using the nitrogen adsorption isotherm have conventionally been proposed. For instance, see a BJH method proposed by Barrett, Joyner and Halenda [Barrett, E. P., Joyner, L. G., and Halenda, P. P., J. Am. Chem. Soc. 73, 373 (1951)], and a DH method proposed by Dollimore and Heal [Dollimore, D., and Heal, G. R., J. Appl. Chem., 14, 109 (1964)], etc. In these methods, when the gas adsorption isotherm is correlated to the size of fine pores, adsorption-desorption phenomena are separated to the formation of a multimolecular adsorption layer on a solid surface and capillary condensation or evaporation, which are analyzed by separate theoretical or empirical equations.

However, it has been found that the size of fine pores determined by these methods tends to be underestimated when the fine pores are mesopores of about several nanometers (Rouquerol, F., et. al., “Adsorption by Powders and Porous Solids: Principles, Methodology and Applications” Academic Press, San Diego, 1999, etc.). Accordingly, a method for accurately evaluating as small pore size as several nanometers in porous materials has been desired.

### OBJECTS OF THE INVENTION

Accordingly, an object of the present invention is to provide a nanoporous inorganic material with a three-dimensionally regular porous structure having fine pores on a nanometer order.

Another object of the present invention is to provide a method for effciently producing such a nanoporous inorganic material at a low temperature and thus at a low cost.

A further object of the present invention is to provide a method for acurrately evaluating the pore size of such a nanoporous inorganic material.

### DISCLOSURE OF THE INVENTION

As a result of intensive research in view of the above objects, the inventors have found that a nanoporous inorganic material with high three-dimensional regularity (specificity) is obtained by preparing a solution containing a metal alkoxide as a starting material of an inorganic material and a cationic surfactant; hydrolyzing the metal alkoxide under a low-temperature, acidic condition, and then slowly drying the resultant hydrolyzate. The present invention has been accomplished by this finding.

Thus, the nanoporous inorganic material with high three-dimensional regularity has a large number of fine pores having a nanometer-order size in an inorganic skeleton structure, a pore size of 0.5 to 5 nm at a peak of a pore size distribution determined from a nitrogen adsorption isotherm, and a half-width of 1 (2θ/degree) or less in an X-ray diffraction peak of a (100) plane.

The nanoporous inorganic material of the present invention having such a structure has fine pores having extremely small pore size, with excellent three-dimensional regularity, self-supportability, durability and mechanical properties.

The nanoporous inorganic material according to one preferred embodiment of the present invention has a pore size of 1 to 3 nm obtained from a nitrogen adsorption isotherm. In the preferred embodiment, a partition walls of the fine pores has a thickness of 0.5 to 3 nm.

The inorganic material is preferably an oxide of at least one element selected from the group consisting of silicon, aluminum, titanium and zirconium, and particularly silica or almina-containing silica.

The method for producing the above nanoporous inorganic material of the present invention comprises the steps of (1) dissolving a metal alkoxide as a starting material for the inorganic material together with a cationic surfactant in a solvent containing water and an alcohol; (2) hydrolyzing the metal alkoxide by adding an acid to the resultant solution; (3) evaporating the solvent from the resultant hydrolyzate at a temperature from room temperature to 50° C.; and (4) firing the resultant inorganic material-surfactant composite with high three-dimensional regularity to remove an organic material therefrom.

A quaternary ammonium surfactant subjected to columnar arrangement with three-dimensional regularity in a solution is preferably used as the cationic surfactant. The quaternary ammonium surfactant is particularly a halogenated tetraalkylammonium represented by the general formula: (R¹, R², R³)R⁴ₙN⁺X⁻; wherein R¹, R² and R³ respectively represent a short-chain alkyl group having 1 or 2 carbon atoms, which may be the same or different; R⁴ represents a long-chain alkyl group having 4 to 22 carbon atoms; X represents a halogen; n represents an integer of 1 or 2; and when n is 2, R³ is not added. A preferred example of such halogenated tetraalkylammonium is halogenated alkyltrimethylammonium or halogenated alkyltriethylammonium. The pore size of the nanoporous inorganic material can be controlled by the number of carbon atoms in the long-chain alkyl group in the halogenated tetraalkylammonium.

The solvent for hydrolysis is preferably composed of water and an alcohol at a water/alcohol molar ratio of 0.2 to 10.

The pH of the solution for hydrolysis is preferably 1.5 to 5, more preferably 2 to 4.5. Said hydrolysis temperature is preferably from room temperature to 60° C. Said firing temperature of the inorganic material-surfactant composite is preferably 350 to 800° C.

The method for evaluating the above nanoporous inorganic material of the present invention comprises:

(a) using the nitrogen adsorption isotherm of the nanoporous inorganic material to determine the critical radius r_{c} of the fine pores and the thickness t of a multimolecular adsorption layer by the following equations (1) and (2):

$$\begin{matrix}- RT ln ( p / {p}_{0} ) - F ( t ) = \frac{{γ}_{∞} {V}_{m}}{r - t} , \\ and & ( 1 ) \\ {r}_{c} = \frac{{γ}_{∞} {V}_{m} + \sqrt{{( {γ}_{∞} {V}_{m} )}^{2} + 2 {γ}_{∞} {V}_{m} δ RT ln ( p / {p}_{0} )}}{- RT ln ( p / {p}_{0} )} , & ( 2 )\end{matrix}$$

wherein r_{c}: the critical radius of fine pores, at which the capillary condensation of an adsorbate occurs;

t: the thickness of a multimolecular adsorption layer of the adsorbate;

p/p₀: the ratio of a pressure p of the adsorbate to a saturated vapor pressure p₀ at a measured temperature (relative pressure);

γ_{∞}: the interfacial tension of the adsorbate in a bulk liquid state;

Vₘ: the molar volume of the adsorbate in a bulk liquid state;

δ: a constant representing the displacement of a zero-absorption surface relative to the interfacial tension surface; and

F(t)=RT[A/t²−B]×ln C, wherein A, B and C are constants determined by this system;

(b) calculating a pore radius r by the equation: r=t+r_{c}; and

(c) using a peak of a pore size distribution obtained therefrom as the pore size of the nanoporous inorganic material.

### BRIEF DESCRIPTION OF THE DRAWINGS

FIG. 1 is a schematic cross-sectional view showing the arrangement of fine pores in the nanoporous inorganic material of the present invention;

FIG. 2 is a flowchart schematically showing the production principle of the nanoporous inorganic material of the present invention;

FIG. 3 is a graph showing the nitrogen adsorption isotherms of porous silica obtained in Example 1;

FIG. 4 is a graph showing the pore size distributions of porous silica in Example 1;

FIG. 5 is a graph showing the X-ray diffraction pattern of porous silica obtained from each CₙTAC in Example 1;

FIG. 6 is a graph showing the relations between the pore size Dp and center distance R of fine pores in porous silica in Example 1 and the number n of carbon atoms in CₙTAC;

FIG. 7 is a graph showing the X-ray diffraction patterns of porous silica obtained at various molar ratios of [C₁₆TAC]/[TEOS] in Example 1; and

FIG. 8 is a graph showing the amount of methanol adsorbed into porous materials in Example 2 and Comparative Examples 1 and 2.

### DETAILED DESCRIPTION OF THE PREFERRED EMBODIMENTS

[1] Nanoporous Inorganic Material

(1) Inorganic Materials

Examples of inorganic materials for forming the skeleton of the nanoporous inorganic material of the present invention include oxides of metal elements in Groups IVA and IVB of the Periodic Table. Preferable among them is an oxide of at least one metal selected from the group consisting of silicon, aluminum, titanium and zirconium, to obtain the nanoporous inorganic material with excellent three-dimensional regularity. Particularly preferable is a metal oxide based on silicon, for instance, silica or almina-containing silica.

(2) Three-Dimensional Regularity

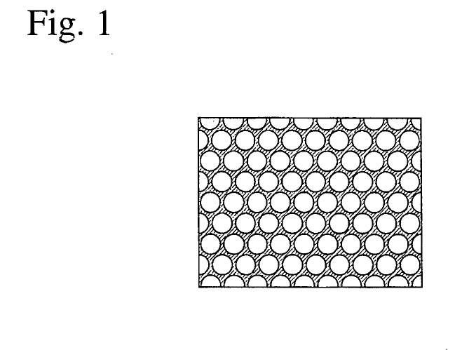

The nanoporous inorganic material of the present invention has a structure, in which fine pores having an extremely uniform pore size as schematically shown in FIG. 1 are hexagonally arranged. It may be said that the nanoporous inorganic material having such a fine porous structure has excellent three-dimensional regularity.

The three-dimensional regularity can be evaluated by a half-width of the X-ray diffraction peak of a (100) plane of the nanoporous inorganic material. In general, the smaller the half-width of an X-ray diffraction peak of an inorganic material, the higher the crystallinity of the inorganic material. In the case of a nanoporous inorganic material, it has been found that the half-width is also correlative to the regularity of fine pores (pore size distribution and three-dimensional arrangement). When the nanoporous inorganic material of the present invention has a half-width of 1° or less in the X-ray diffraction peak of a (100) plane, it is considered that the nanoporous inorganic material has excellent three-dimensional regularity. The half-width is preferably 0.8° or less, more preferably 0.6° or less, and particularly 0.3° or less.

(3) Fine Pores

(a) Pore Size

In the present invention, a pore size at a peak of a pore size distribution obtained from a nitrogen adsorption isotherm by the following equations (1) and (2) is used as the pore size of the nanoporous inorganic lo material. The pore size thus obtained is 0.5 to 5 nm, preferably 1 to 3 nm.

$$\begin{matrix}- RT ln ( p / {p}_{0} ) - F ( t ) = \frac{{γ}_{∞} {V}_{m}}{r - t} , \\ and & ( 1 ) \\ {r}_{c} = \frac{{γ}_{∞} {V}_{m} + \sqrt{{( {γ}_{∞} {V}_{m} )}^{2} + 2 {γ}_{∞} {V}_{m} δ RT ln ( p / {p}_{0} )}}{- RT ln ( p / {p}_{0} )} . & ( 2 )\end{matrix}$$

r_{c}: the critical radius of fine pores, at which the capillary condensation of an adsorbate occurs;

t: the thickness of a multimolecular adsorption layer of the adsorbate;

p/p₀: the ratio of a pressure p of the adsorbate to a saturated vapor pressure p₀ at a measured temperature (relative pressure);

γ_{∞}: the interfacial tension of the adsorbate in a bulk liquid state;

Vₘ: the molar volume of the adsorbate in a bulk liquid state;

δ: a constant representing the displacement of a zero-absorption surface relative to the interfacial tension surface; and

F(t)=RT[A/t²−B]×ln C, wherein A, B and C are constants determined by this system.

The equation (1) was proposed by Broekhoff and de Boer (Broekhoff, J. C. P., and de Boer, J. H., J. Catal. 10, 377 (1968)). The equation (2) was a revision of the Kelvin equation. In the equation of F(t), each of the constants A, B and C is determined by the type of a nanoporous inorganic material. In the case of porous silica, for instance, A is 0.1399, B is 0.034, and C is 10.

(b) Thickness t of Multimolecular Adsorption Layer

It is important to accurately measure the thickness t of a multimolecular adsorption layer to obtain an accurate pore size. In general, the evaluation of a phenomenon of gas adsorption onto a porous material requires to know the phenomena of the formation of an adsorption layer not only on an outer surface but also in fine pores. Particularly, the formation of the adsorption layer in the fine pores of the nanoporous inorganic material is different from the formation of the adsorption layer on a usual solid surface because the pore size is extremely small. In addition, the surface area of the porous material is mostly occupied by those of the fine pores.

Paying attention to the fact that an interface between a multimolecular adsorption layer and a gas phase has a larger curvature in fine pores than in a nonporous surface, the inventors have come to consider that such a large curvature has an unnegligible effect on the formation of the multimolecular adsorption layer in the fine pores. Thus, the equations (1) and (2) are combined to determine the thickness t of the multimolecular adsorption layer.

(c) Critical Radius r_{c} for Causing Capillary Condensation

The critical radius r_{c} for causing capillary condensation in fine pores at a relative pressure p/p₀, which is calculated by the following equation (3):

$${r}_{c} = \frac{- 2 {γ}_{∞} {V}_{m}}{RT ln ( p / {p}_{0} )} , \qquad ( 3 )$$

tends to be smaller than the measured one in a range that p/p₀ is 0.3 or less. Particularly at around the p/p₀ of about 0.2 corresponding to the pore size of 2 nm, the critical radius r_{c} calculated by the Kelvin equation is underestimated by about 0.1 to 0.2 nm. Accordingly, the inventors have revised the Kelvin equation to the equation (2) to accurately estimate the critical radius r_{c} at around the p/p₀ of 0.2.

When the critical radius r_{c} calculated by the equation (2) is used for the equation (1), the thickness t of a multimolecular adsorption layer is obtained. Because the pore radius r is represented by the equation: r=t+r_{c}, the pore radius is obtained from the thickness t of the multimolecular adsorption layer calculated by the equations (1) and (2), and the critical radius r_{c}. A pore size distribution is depicted on a graph by plotting the pore size (2r) at each relative pressure p/p₀, and a pore size at a peak of the pore size distribution is used as the pore size of fine pores in the nanoporous inorganic material.

With respect to porous silica, the comparison of the calculated thickness t of a multimolecular adsorption layer and the calculated critical radius r_{c}, at which capillary condensation occurs, with the measured ones reported by Naono, et al. [Naono, H., Haruman, M., and Shiono, T., J. Colloid. Interface Sci. 186, 360 (1997)] has confirmed that they approximately agree.

(d) Thickness of Partition Walls

The nanoporous inorganic material of the present invention is characterized in having not only fine pores having an extremely small pore size but also extremely thin partition walls of the fine pores. The partition walls are as thick as about 0.5 to 3 nm. Because of such thin partition walls, the nanoporous inorganic material of the present invention has high porosity.

[2] Method for Producing Nanoporous Inorganic Material

(1) Starting Materials for Inorganic Materials

The starting materials for the inorganic materials are preferably alkoxides of metal elements in Gropes IVA and IVB of the Periodic Table, specifically alkoxides of at least one metal selected from the group consisting of silicon, aluminum, titanium and zirconium. Particularly preferable is a metal oxide based on silicon, for instance, silica or almina-containing silica. In the case of inorganic materials containing pluralities of metals like zeolite, the metal alkoxides may be used in combination.

The silicon alkoxide is preferably Si(OR₁)₄, wherein R₁ represents a lower alkyl group having dimensional 1 to 6 carbon atoms, particularly tetramethoxysilicate [Si(OCH₃)₄], tetraethoxysilicate [Si(OC₂H₅)₄], etc.

The aluminum alkoxide is preferably Al(OR₂)₃, wherein R₂ represents a lower alkyl group having 1 to 6 carbon atoms, particularly Al(OCH₃)₃, Al(OC₂H₅)₃, Al(O-iso-C₃H₇)₃, Al(OC₄H₉)₃, etc.

The titanium alkoxide is preferably Ti(OR₃)₄, wherein R₃ represents a lower alkyl group having I to 6 carbon atoms, particularly Ti(OCH₃)₄, Ti(OC₂H₅)₄, Ti(O-iso-C₃H₇)₄, Ti(OC₄H₉)₄, etc.

The zirconium alkoxide is preferably Zr(OR₄)₄, wherein R₄ represents a lower alkyl group having 1 to 6 carbon atoms, particularly Zr(OCH₃)₄, Zr(OC₂H₅)₄, Zr(O-iso-C₃H₇)₄, Zr(OC₄H₉)₄, etc.

(2) Cationic Surfactant

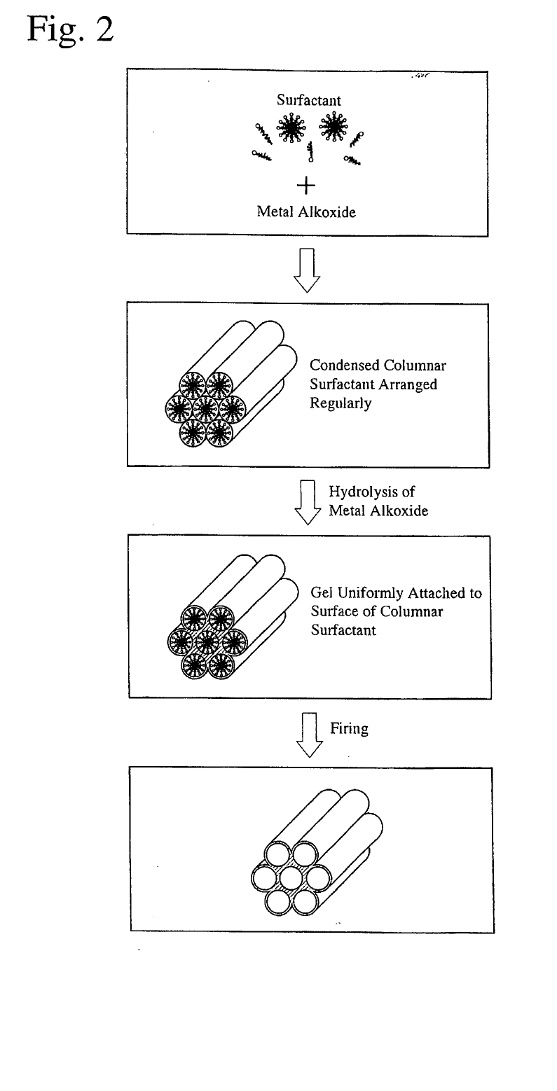

The cationic surfactant is a material, which is dissolved in a solvent together with the starting material for the inorganic material to function as a template (mold) for forming fine pores in the nanoporous inorganic material. Therefore, as shown in FIG. 2, the cationic surfactant should be subjected to columnar arrangement with high three-dimensional regularity in the solution.

Such a cationic surfactant is preferably quaternary ammonium, particularly a halogenated tetraalkylammonium represented by the general formula: (R¹, R², R³)R⁴ₙN⁺X⁻, wherein R¹, R² and R³ respectively represent a short-chain alkyl group having 1 or 2 carbon atoms, which may be the same or different; R⁴ represents a long-chain alkyl group having 4 to 22 carbon atoms; X represents a halogen; n represents an integer of 1 or 2; and when n is 2, R³ is not added. A preferred examples of such a halogenated tetraalkylammonium is halogenated alkyltrimethylammonium or halogenated alkyltriethylammonium. The halogen X is preferably chlorine or bromine.

The pore size of the nanoporous inorganic material depends on the number of carbon atoms in the long-chain alkyl group R⁴ in the halogenated tetraalkylammonium. The pore size of the fine pores generally increases as the number of carbon atoms in the long-chain alkyl group R⁴ increases. Accordingly, the pore size of the fine pores in the nanoporous inorganic material may be adjusted by changing the number of the carbon atoms in the long-chain alkyl group R⁴. Particularly when the number of carbon atoms in the long-chain alkyl group R⁴ in the halogenated alkyltrimethylammonium is 4 to 22, the pore size of the fine pores in the nanoporous inorganic material may be controlled to a range of 0.5 to 5 nm, preferably 1 to 3 nm

(3) Solvent

The solvent for preparing a solution for hydrolysis is composed of water and an alcohol. Specific examples of alcohols include lower alcohols such as methanol, ethanol, n-propyl alcohol, isopropyl alcohol, n-buthanol, etc. Ethanol is particularly preferable from the view points of volatility, cost and handling.

When an alcohol solution is used, the molar ratio of water to an alcohol is preferably 0.2 to 10. When the water/alcohol molar ratio is less than 0.2, sufficient hydrolysis does not occur. On the other hand, when the water/alcohol molar ratio exceeds 50, the amount of water is too much, requiring too long a period of time to dry the hydrolyzate. The preferable water/alcohol molar ratio is 0.5 to 5.

(4) Hydrolysis

(a) Composition of Solution for Hydrolysis

The composition of a solution comprising the metal alkoxide and the surfactant greatly affects the pore size and three-dimensional regularity of the resultant nanoporous inorganic material. The hydrolysis solution in the present invention has a higher concentration than solutions used in usual sol-gel methods.

Specifically, the molar ratio of water to the metal alkoxide is preferably in a range of 1.5 to 40. When the water/metal alkoxide molar ratio is less than 1.5, the concentration of the metal alkoxide is too high to achieve a sufficient hydrolysis reaction. On the other hand, when the molar ratio exceeds 40, the concentration of the metal alkoxide is too low, resulting in too slow a hydrolysis reaction. The water/metal alkoxide molar ratio is more preferably 2 to 20.

The surfactant/solvent molar ratio is preferably in a range of 1/50 to 1/200. When the surfactant/solvent molar ratio is less than 1/200, fine pores are not arranged with high three-dimensional regularity because the metal alkoxide is hydrolyzed before the surfactant is liquid-crystalized. When the surfactant/solvent molar ratio exceeds 1/50, the surfactant is deposited in the solution because of too high concentration. The surfactant/solvent molar ratio is more preferably 1/70 to 1/150.

The surfactant/metal alkoxide molar ratio is preferably in a range of 1/10 to 5/10. When this molar ratio is less than 1/10, the amount of the surfactant is too small, and thus gellation is too slow to obtain a composite with high three-dimensional regularity. On the other hand, when this molar ratio exceeds 5/10, the composite does not have a hexagonal structure, resulting in low three-dimensional regularity. The surfactant/metal alkoxide molar ratio is more preferably 1.5/10 to 4/10.

(b) Addition of Acid

A uniform solution containing the metal alkoxide and the surfactant is uniformly mixed with a dilute acid at a low temperature to hydrolyze the metal alkoxide. Not particularly restricted, the acid may be mineral acids such as hydrochloric acid, sulfuric acid and nitric acid, organic acids such as acetic acid and tartaric acid. Hydrochloric acid is preferable because it can be completely removed during firing. The amount of the acid added is preferably determined to adjust the pH of the solution to a range of 1.5 to 5. When the solution is as acidic as pH 1.5 to 5, the nanoporous inorganic material is provided with high three-dimensional regularity. The pH of the solution is more preferably 2 to 4.5.

To obtain the solution with pH 1.5 to 5, the amount of the acid added is preferably 0.0001 to 0. 1 mol, more preferably 0.0005 to 0.05 mol, per 1 mol of the metal alkoxide. The acid is preferably added in a dilute state. Specifically, the concentration of the dilute acid is preferably 5×10⁻⁴ to 10⁻¹ M. The pH of the solution is measured by a pH meter immersed in the solution.

(b) Other Hydrolysis Conditions

Though the metal alkoxide can be hydrolyzed without heating, it may be heated to a low temperature for hydrolysis. The preferable hydrolysis temperature is room temperature to 60° C. When the hydrolysis temperature is higher than 60° C., the resultant composite fail to have fine pores with high three-dimensional regularity. On the other hand, when the hydrolysis temperature is lower than room temperature, the surfactant is deposited in the solution. The hydrolysis temperature is preferably room temperature to 40° C.

(5) Gellation

The hydrolysis of the metal alkoxide forms a metal oxide gel through a sol. Because the metal oxide gel is wet, the composite of the inorganic material and the surfactant is obtained by slow drying at a temperature from room temperature to 50° C. The drying should be conducted as slowly as possible. If the hydrolyzate were dried quickly, the porous material shrinks drastically by the evaporation of the solvent, resulting in cracking and damage in the porous material. Accordingly, after the completion of a hydrolysis reaction, the solution may be transferred, for instance, to a glass dish and air-dried at room temperature.

As shown in FIG. 2, the resultant composite has a structure comprising the cationic surfactant arranged with high three-dimensional regularity and the metal oxide (or hydroxide) gel uniformly attached to the cationic surfactant. The metal oxide gel has sufficient mechanical strength free from cracks.

(6) Firing

The completely dried composite of the inorganic material and the surfactant is fired at a temperature of preferably 350 to 800° C., more preferably 400 to 700° C., to completely remove the organic material from the composite. The regularly arranged cationic surfactant compeletly disapears, is leaving regularly arranged fine pores, and thus resulting in the nanoporous inorganic material with high three-dimensional regularity as shown in FIG. 2.

The present invention will be explained in more detail referring to Examples below without intention of restricting the scope of the present invention.

### EXAMPLE 1

### (1) Preparation of Porous Silica

0.01 mol of tetraethoxysilicate (TEOS, “T0100” available from Tokyo Kasei Kogyo Co., Ltd., purity: 96% or more) was used as a silicon alkoxide, and alkyltrimethylammonium chloride (CₙTAC, wherein n is an integer of 10 to 18 representing the number of carbon atoms in a long-chain alkyl group, “H0082”, purity: 98% or more) was used as a cationic surfactant. The number of carbon atoms in the long-chain alkyl group in the alkyltrimethylammonium chloride is shown in Table 1. 0.01 mol of TEOS and various amounts of CₙTAC were dissolved in 0.10 mol of ethanol (special-grade chemical available from Wako Pure Chemical Industries, Ltd., purity: 99.5% or more by volume), and stirred by a magnetic stirrer to obtain a uniform solution.

1.80 g of an aqueous hydrochloric acid solution (10⁻³M) was added to each solution, and the resultant mixed solution was stirred at room temperature for 5 hours to hydrolyze TEOS. The pH of the hydrolysis solution measured by a pH meter was 3.9 during stirring and 3.57 after the completion of stirring. The hydrolyzed solution was transferred to a glass dish and left at 25° C. for one day for air drying. The resultant silica-CₙTAC composite was fired at 600° C. for 5 hours to completely remove CₙTAC, to obtain porpous silica. Each composition of the hydrolysis solution is shown in Table 1.

TABLE 1

| CₙTAC | | | | Aqueous |
|---|---|---|---|---|
| Number n of Carbon | | | | Hydrochloric |
| Atoms in Long-Chain | Amount | TEOS | Ethanol | Acid Solution |
| Alkyl Group | (10⁻³ mol) | (mol) | (mol) | (g) |
| 10 | 2.8-3.2 | 0.01 | 0.10 | 1.80 |
| 12 | 2.3-2.7 | 0.01 | 0.10 | 1.80 |
| 14 | 2.3-2.7 | 0.01 | 0.10 | 1.80 |
| 16 | 1.8-2.2 | 0.01 | 0.10 | 1.80 |
| 18 | 1.8-2.2 | 0.01 | 0.10 | 1.80 |

### (2) Evaluation of Porous Silica

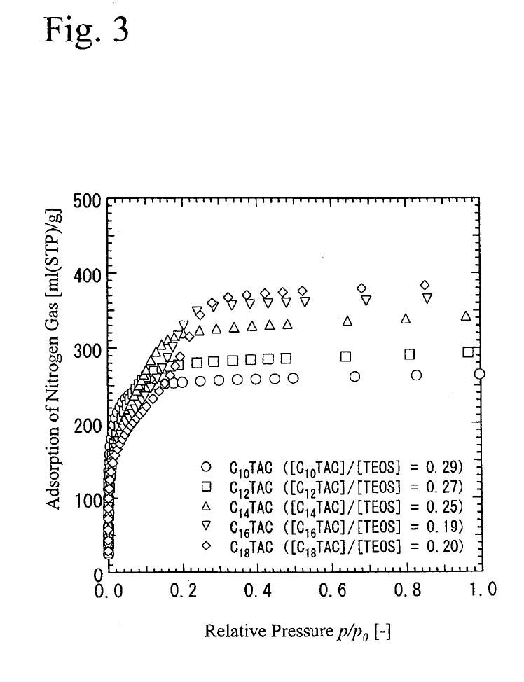

The absorption properties of each porous silica were evaluated by using a nitrogen gas. The resultant adsorption isotherms are shown in FIG. 3. Though both adsorption and desorption of a nitrogen gas were measured on each porous silica, only the adsorption isotherms are shown in FIG. 3 because of no hysteresis in the adsorption and desorption isotherms. As is clear from the nitrogen adsorption isotherms shown in FIG. 3, the amount of nitrogen adsorbed in the porous silica of this Example drastically increased in a relative pressure p/p₀ range of 0 to 0.2, and was substantially saturated in a range of p/p₀>0.4, regardless of the number n of carbon atoms in CₙTAC as the cationic surfactant.

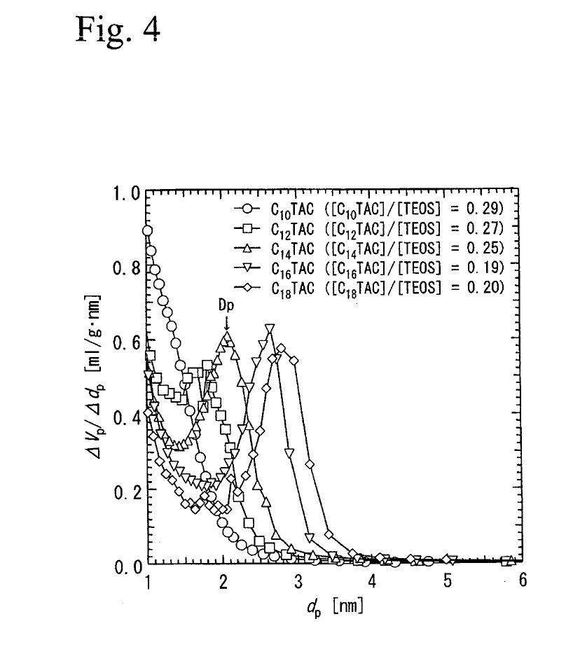

The pore size distribution of the porous silica was determined from the nitrogen adsorption isotherms shown in FIG. 3 by the equations (1) and (2). The resultant pore size distributions are shown in FIG. 4. In FIG. 4, ΔVp represents change in the amount of nitrogen adsorbed in a small pore size range Δdp, and ΔVp/Δdp represents a volume at each pore size. A pore size at a peak of the pore size distribution of each porous material shown in FIG. 4 was used as a pore size Dp. The pore size Dp is shown in Table 2. As is clear from Table 2, the porous silica produced by using C₁₂TAC as a template had the smallest pore size Dp of 1.81 nm. The pore size distribution did not show any peak in the case of C₁₀TAC, presumably because the pore size was too small for accurate measurement by nitrogen adsorption.

As is clear from FIG. 4 and Table 2, the peak of the pore size distribution shifted to the smaller side, as the number of carbon atoms in CₙTAC decreased. It is thus clear that the pore size distribution of the porous material can be controlled by changing the number n of carbon atoms in the long-chain alkyl group in CₙTAC used as the cationic surfactant.

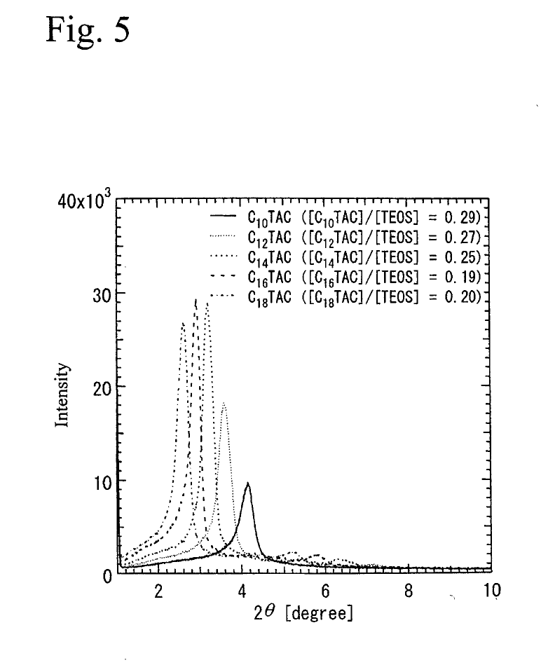

With respect to these porous silica, an X-ray diffraction (XRD) analysis was conducted. The results are shown in FIG. 5. Any porous silica produced by using CₙTAC had a sharp peak corresponding to a (100) plane, indicating high three-dimensional regularity. The half-width of the peak in each CₙTAC is shown in Table 2. Further, a spacing d₍₁₀₀₎ between the (100) planes measured by XRD is also shown in Table 2.

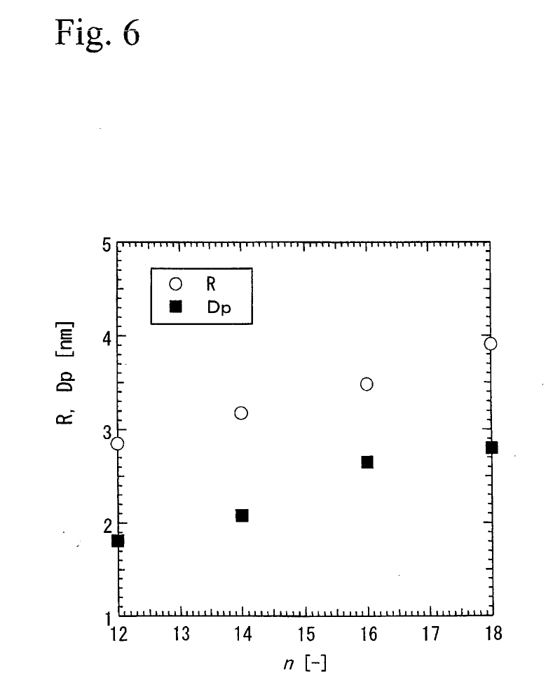

The center distance R between the hexagonally arranged fine pores of the porous silica with 12-18 carbon atoms was calculated by the equation: R=2d₍₁₀₀₎/√3. The calculated center distance R between the fine pores is also shown in Table 2. FIG. 6 is a graph showing the pore size Dp and the center distance R between the fine pores plotted relative to the number n of carbon atoms in CₙTAC. As is clear from FIG. 6, both Dp and R linearly increased at substantially the same gradient as n increased.

The thickness Dw of partition walls separating the hexagonally aligned fine pores can be calculated by the equation Dw=R−Dp. The calculated Dw is also shown in Table 2. It was confirmed from Table 2 that in the porous silica of the present invention, the thickness Dw of the partition walls of the fine pores was substantially as uniform as about 1 nm regardless of the pore size Dp. The pore size Dp was 2.8 nm or less. The total volume Vp of the pores per a unit weight of the porous silica was 0.550 ml/g.

TABLE 2

| | Half-Width | CₙTAC/TEOS | d₍₁₀₀₎ | Vp | Dp | R | Dw |
|---|---|---|---|---|---|---|---|
| n | (°) in XRD | [mol/mol] | (nm) | (ml/g) | (nm) | (nm) | (nm) |
| 10 | 0.365 | 0.29 | 2.13 | — | — | 2.46 | — |
| 12 | 0.306 | 0.27 | 2.47 | 0.432 | 1.81 | 2.85 | 1.04 |
| 14 | 0.247 | 0.25 | 2.75 | 0.499 | 2.08 | 3.18 | 1.10 |
| 16 | 0.247 | 0.19 | 3.02 | 0.550 | 2.65 | 3.48 | 0.83 |
| 18 | 0.212 | 0.20 | 3.38 | 0.567 | 2.80 | 3.91 | 1.11 |

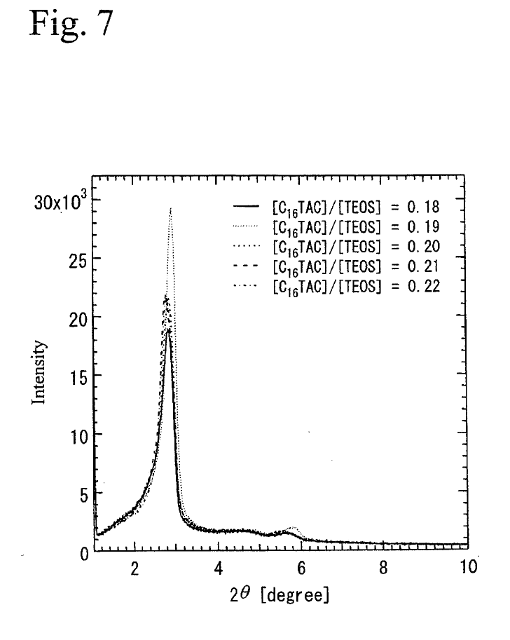

FIG. 7 is a graph showing the X-ray diffraction patterns at various ratios of [C₁₆TAC]/[TEOS], when C₁₆TAC was used. As is clear from FIG. 7, each X-ray diffraction pattern had a sharp peak with a small half-width, regardless of the molar ratio of [C₁₆TAC]/[TEOS].

### EXAMPLE 2, AND COMPARATIVE EXAMPLES 1 and 2

Porous silica having a pore size Dp of 2.6 nm and a half-width of 0.188° at the X-ray diffraction peak of a (100) plane was produced in the same manner as in Example 1 except for using CₙTAC (n=16) at a molar ratio of [C₁₆TAC]/[TEOS] changed to 0.2 (Example 2).

In Comparative Example 1, a silicalite corresponding to zeolite ZSM-5 having a infinite Si/Al ratio and a pore size Dp of 0.6 nm was synthesized by the hydrothermal synthesis method disclosed in JP 53-58499 A.

In Comparative Example 2, MCM-41 having a pore size Dp of 3 nm was synthesized by the hydrothermal synthesis method proposed by J. S. Beck et al. (Beck, J. S.; Vartuli, J. C.; Roth, W. J.; Leonowicz, M. E.; Kresge, C. T.; Schmitt, K. D.; Chu, C. T-W.; Olson, D. H.; Sheppard, E. W.; McCullen, S. B.; Higgins, J. B.; Schlenker, J. L. J. Am. Chem. Soc. 1992, 114, 10834).

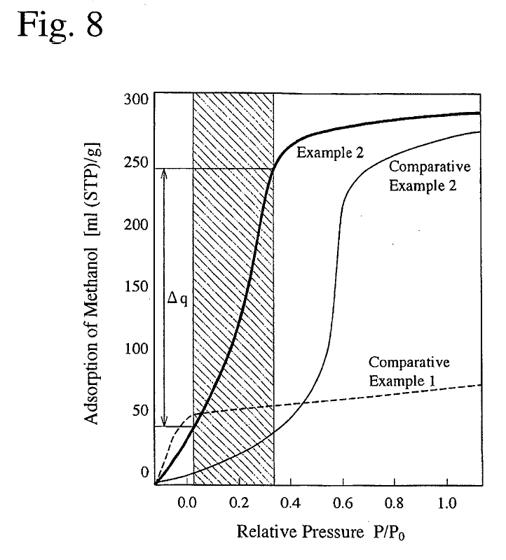

With respect to each porous material, the relation between the amount of methanol adsorbed and a relative pressure was investigated. The results are shown in FIG. 8. A hatched portion in a relative pressure p/p₀ range of about 0.08 to 0.25 in FIG. 8 corresponds to an operation range of an adsorption heat pump (driving heat source: 80 to 100° C., environmental temperature: 25° C., and cold production: −10 to 0° C.). The larger the adsorption difference Δq [ml(STP)/g] in this range, the higher the methanol adsorption.

As is clear from FIG. 8, the silicalite of Comparative Example 1 reached adsorption saturation at a lower relative pressure than that in the operation range, with a small amount of methanol adsorbed at saturation. Though MCM-41 of Comparative Example 2 adsorbed a large amount of methanol at saturation, the adsorption difference Δq was small in the operation range. On the contrary, there was a large adsorption difference Δq in the porous silica of Example 2 in the operation range, with the adsorption saturation of methanol reached at a higher relative pressure. It is thus clear that the porous silica of the present invention is suitable for a heat pump utilizing as low a driving heat source as 80 to 100° C.

### APPLICABILITY IN INDUSTRY

As described in detail above, because the nanoporous inorganic material of the present invention has excellent gas adsorption, mechanical is strength and heat resistance, because it has high three-dimensional regularity, comprising a large number of regularly-arranged fine pores having a nanometer-order pore size. The nanoporous inorganic material of the present invention having such feature is suitable not only for separating means of various separating apparatuses and adsorbing means of various adsorbing/separating apparatuses, but also adsorbing means of chemical heat pumps. It can also be used for catalysts or their carriers. In addition, because it has thin partition walls with large porosity, it is suitable for applications such as electrolytic capacitors, ultra-high voltage fuses, etc., to which high voltage is applied.

The method of the present invention can produce nanoporous inorganic materials having fine pores with high three-dimensional regularity easily at a low cost, because an acid is added to a high-concentration solution of a metal alkoxide and a cationic surfactant to turn it acidic by a sol-gel method, and the solution is hydrolyzed without heating for gellation, thereby forming a three-dimensionally regular complex. In addition, because the production method of the present invention can control the size of fine pores easily, it can be widely used to produce porous materials for various applications.

The method of the present invention for evaluating a pore size can evaluate the size of fine pores on the level of about 2 nm in the nanoporous inorganic materials, which is conventionally underestimated.

1-15. (canceled)

16. A nanoporous inorganic material with high three-dimensional regularity having a large number of fine pores having a nanometer-order size in an inorganic skeleton structure, which has a pore size of 0.5 to 5 nm at a peak of a pore size distribution determined from a nitrogen adsorption isotherm, and a half-width of 1 (2θ/degree) or less in an X-ray diffraction peak of a (100) plane.

17. The nanoporous inorganic material according to claim 16, wherein the peak of the pore size distribution determined from said nitrogen adsorption isotherm is 1 to 3 nm.

18. The nanoporous inorganic material according to claim 16, wherein partition walls of said fine pores are as thick as 0.5 to 3 nm.

19. The nanoporous inorganic material according to any one of claim 16, wherein said inorganic material is an oxide of at least one element selected from the group consisting of silicon, aluminum, titanium and zirconium.

20. The nanoporous inorganic material according to claim 19, wherein said inorganic material is silica or almina-containing silica.

21. A method for producing a nanoporous inorganic material with high three-dimensional regularity having a large number of fine pores having a nanometer-order size in an inorganic skeleton structure, comprising the steps of (1) dissolving a metal alkoxide as a starting material for said inorganic material together with a cationic surfactant in a solvent containing water and an alcohol; (2) hydrolyzing said metal alkoxide by adding an acid to the resultant solution; (3) evaporating said solvent from the resultant hydrolyzate at a temperature from room temperature to 50° C.; and (4) firing the resultant inorganic material-surfactant composite with high three-dimensional regularity to remove an organic material therefrom.

22. The method for producing a nanoporous inorganic material according to claim 21, wherein said metal alkoxide is an alkoxide of at least one metal selected from the group consisting of silicon, aluminum, titanium and zirconium.

23. The method for producing a nanoporous inorganic material according to claim 21, wherein a quaternary ammonium surfactant subjected to columnar arrangement with high three-dimensional regularity in said solution is used as said cationic surfactant.

24. The method for producing a nanoporous inorganic material according to claim 23, wherein said quaternary ammonium surfactant is halogenated tetraalkylammonium represented by the general formula: (R¹, R², R³)R⁴ₙN⁺X⁻; wherein R¹, R² and R³ respectively represent a short-chain alkyl group having 1 or 2 carbon atoms, which may be the same or different; R⁴ represents a long-chain alkyl group having 4 to 22 carbon atoms; X represents a halogen; n represents an integer of 1 or 2; and when n is 2, R³ is not added.

25. The method for producing a nanoporous inorganic material according to claim 24, wherein a pore size of said nanoporous inorganic material is controlled by the number of carbon atoms in said long-chain alkyl group in said halogenated tetraalkylammonium.

26. The method for producing a nanoporous inorganic material according to claim 21, wherein said solution for hydrolysis has pH of 1.5 to 5.

27. The method for producing a nanoporous inorganic material according to claim 21, wherein said solvent is composed of water and an alcohol at a water/alcohol molar ratio of 0.2 to 10.

28. The method for producing a nanoporous inorganic material according to claim 21, wherein said hydrolysis is conducted at a temperature from room temperature to 60° C.

29. The method for producing a nanoporous inorganic material according to claim 21, wherein said inorganic material-surfactant composite is fired at 350 to 800° C.

30. A method for evaluating the nanoporous inorganic material recited in claim 21, comprising:
(a) using the nitrogen adsorption isotherm of said nanoporous inorganic material to determine the critical radius r_{c} of said fine pores and the thickness t of a multimolecular adsorption layer by the following equations (1) and (2):
$$\begin{matrix}- RT ln ( p / {p}_{0} ) - F ( t ) = \frac{{γ}_{∞} {V}_{m}}{r - t} , \\ and & ( 1 ) \\ {r}_{c} = \frac{{γ}_{∞} {V}_{m} + \sqrt{{( {γ}_{∞} {V}_{m} )}^{2} + 2 {γ}_{∞} {V}_{m} δ RT ln ( p / {p}_{0} )}}{- RT ln ( p / {p}_{0} )} , & ( 2 )\end{matrix}$$
wherein r_{c}: the critical radius of fine pores, at which the capillary condensation of an adsorbate occurs;
t: the thickness of a multimolecular adsorption layer of the adsorbate;
p/p₀: the ratio of a pressure p of the adsorbate to a saturated vapor pressure p₀ at a measured temperature (relative pressure);
γ_{∞}: the interfacial tension of the adsorbate in a bulk liquid state;
Vₘ: the molar volume of the adsorbate in a bulk liquid state;
δ: a constant representing the displacement of a zero-absorption surface relative to the interfacial tension surface; and
F(t)=RT[A/t²−B]×ln C, wherein A, B and C are constants determined by this system;
(b) calculating a pore radius r by the equation: r=t+r_{c}; and
(c) using a peak of a pore size distribution obtained therefrom as the pore size of said nanoporous inorganic material.
